(19) United States
(12) Patent Application Publication
(10) Pub. No.: US 2012/0129146 A1
(43) Pub. Date: May 24, 2012

(54) ERASABLE WRITING PANEL INTEGRATED INTO ARTICLES

(75) Inventor: Roshan WIJERAMA, Chester, NJ (US)

(73) Assignee: Horizon Group USA, Inc., Warren, NJ (US)

(21) Appl. No.: 12/949,579

(22) Filed: Nov. 18, 2010

(51) Int. Cl. B43L 1/00; B42D 1/00

(52) U.S. Cl. 434/408; 281/15.1

(57) ABSTRACT

Various articles, such as notebooks, notepads, journals and folders, that include an integrated or integral erasable writing panel. The writing panel may be a cover member of the article, e.g., on a front surface thereof, and includes a substrate and a transparent or translucent sheet superposed relative to the substrate to overlie or be apart from the substrate.

### FIELD OF THE INVENTION

The present invention is directed to commonly used articles, e.g., for writing, schoolwork and office work, that include an integrated or integral erasable writing panel.

### BACKGROUND OF THE INVENTION

Stand-alone erasable writing panels are known in the art. One type of panel includes a rigid substrate to which a flexible transparent sheet of plastic is pivotally attached to overlie the rigid substrate. In use, when pressure is applied to the overlying plastic against the substrate, the pressure causes the plastic to appear to change its color, i.e., darken, and thereby adopt the form or shape in which the pressure is applied. Thus, a user can write, by applying pressure in the form of letters, or create a design by applying pressure in the form of the desired design.

Thereafter, when the user wants to “erase” the formed writing or design, the user lifts the overlying plastic away from the substrate, thereby causing erasure of the writing or design. To form a subsequent writing or design, the plastic is again placed against the substrate and is ready for re-use.

### SUMMARY OF THE INVENTION

An article of use in accordance with the invention integrates an erasable writing panel so that the article can serve at least two functions, as an erasable writing panel and for the designed purpose of the article itself because the erasable writing panel is incorporated into the article in a manner avoid interfering with the intended use of the article. Possible articles in accordance with the invention includes a notebook, journal, folder, pad of paper, stationery supplies, school supplies, office supplies and office storage supplies, and the like. This list is not intended to be exhaustive but suggestive of the types of articles.

Accordingly, a first embodiment of an article in accordance with the invention includes a front cover member, and a rear cover member operatively coupled to the front cover member. The front cover member includes a substrate and a transparent sheet superposed relative to the substrate to overlie or be apart from the substrate. In a variation of the first embodiment the article includes a plurality of sheets of paper which enables the article to be used as a notebook, journal, notepad and the like, while the front cover member enables the article to be used as an erasable writing panel.

A second embodiment of an article in accordance with the invention is a folder that includes a front panel and a rear panel wherein at least one of the front and rear panels define a pocket, the rear panel being pivotally coupled to the front panel, and a front cover member comprising a substrate and a transparent sheet superposed relative to the substrate to overlie or be apart from the substrate. The front and rear panels enable the article to be used as a folder in a conventional manner, receiving loose sheets of paper and the like, while the front cover member enables the article to be used as an erasable writing panel.

A third embodiment of an article in accordance with the invention is a loose-leaf notebook including a front panel, a rear panel, a side panel that operatively couples the front and rear panels, and a binder structure coupled to the side panel and that removably receives sheets of paper. The front panel includes a cover member having a substrate and a transparent sheet superposed relative to the substrate to overlie or be apart from the substrate. The front, rear and side panels and binder structure enable the article to be used as a loose-leaf notebook in a conventional manner, receiving loose sheets of paper and the like, while the cover member of the front panel enables the loose-leaf notebook to be used an erasable writing panel.

### BRIEF DESCRIPTION OF THE DRAWINGS

The invention may best be understood by reference to the following detailed description of and illustrative embodiment when read in conjunction with accompanying drawings, wherein:

FIG. 1 is a front view of a spiral notebook in accordance with the invention;

FIG. 2 is a cross-sectional view of the spiral notebook taken along the line 2-2 of FIG. 1;

FIG. 3 is a front view of a pad of paper in accordance with the invention;

FIG. 4 is a cross-sectional view of the pad of paper taken along the line 4-4 of FIG. 3;

FIG. 5 is a front, perspective view of a folder in accordance with the invention;

FIG. 6 is a cross-sectional view of the folder taken along the line 6-6 of FIG. 5;

FIG. 7 is a front, perspective view of a loose-leaf notebook in accordance with the invention; and

FIG. 8 is a cross-sectional view of the loose-leaf notebook taken along the line 8-8 of FIG. 7.

### DETAILED DESCRIPTION OF THE INVENTION

Referring to the accompanying drawings wherein the same reference numbers refer to the same or similar elements, FIGS. 1 and 2 illustrate a first embodiment of an article in accordance with the invention which is a spiral notebook 10 having a plurality of sheets of paper 12, a back cover member 14 and a front cover member 16, all of which are operatively coupled to a spiral 18.

The front cover member 16 has a construction that provides a surface to enable erasable writing thereon. Specifically, the front cover member 16 includes a substrate 20 (which can be rigid, semi-rigid, or non-rigid) and a transparent sheet 22 (for example, flexible plastic) operatively coupled (pivotally attached) to one edge region 24 of the substrate 20, e.g., the upper edge region as shown, and that overlies the substrate 20. The substrate 20 may be the same member that bounds the sheets 12 on the top or a separate member, i.e., the substrate 20 is part of the front cover member 16 which is placed against another cover that binds the sheets 12 on the top. In one embodiment, the sheet 22 may be attached to a part of the front cover member 16 of the notebook 10 other than the substrate 20, but such that it overlies the substrate 20.

The sheet 22 is sized to avoid interfering with the spiral 18 and thereby enable the sheet 22 to be easily lifted to be out of contact with the substrate 20 and returned to be in contact with the substrate 20. To this end, corner regions 26 of the sheet 22 may be removed to enable lifting up of the sheet 22 from the substrate 20 (see FIG. 1).

In use, when pressure is applied to the overlying sheet 22 against the substrate 20, the pressure causes the sheet 22 to change its color, i.e., darken, and thereby adopt the form or shape in which the pressure is applied.

The materials for the substrate 20 and the sheet 22 are known to those skilled in the art, such as those used for known peel-back dry erase drawing boards such as that sold by The Print Box Inc. of New York, N.Y. under the name Magic Slate.

In addition, it is possible to include with the notebook a stylus 28 that can be used to apply pressure to the plastic sheet 22. The stylus 28 may be sized to fit in the spiral 18 for storage. Alternatively, as known in the art with such substrates and sheets, a user can use a fingernail or other object to apply pressure to the sheet 22 and substrate 20 to form an image.

When the user wants to “erase” the formed writing, design, or image appearing when viewing the sheet 22, the user lifts or pivots the sheet 22 to separate away from the substrate 20, thereby causing erasure of the writing, design or image. To ready the front cover member 16 for re-use, the sheet 22 is again placed in contact with the substrate 20.

The size and shape of the spiral notebook 10 may vary as desired. Indeed, a plurality of different size and shape spiral notebooks may be produced, each including a front cover member 16 as described above. The front cover member 16 may occupy the maximum amount of area on the front of the spiral notebook 10, without interfering with the spiral 18, or only a portion thereof. Multiple transparent sheets may be provided, each overlying a discrete portion of the substrate 20 and each independently attached to substrate 20. As such, different writing or designs may be produced, and each erased independent of the continued presence or erasure of the other writing, image or design.

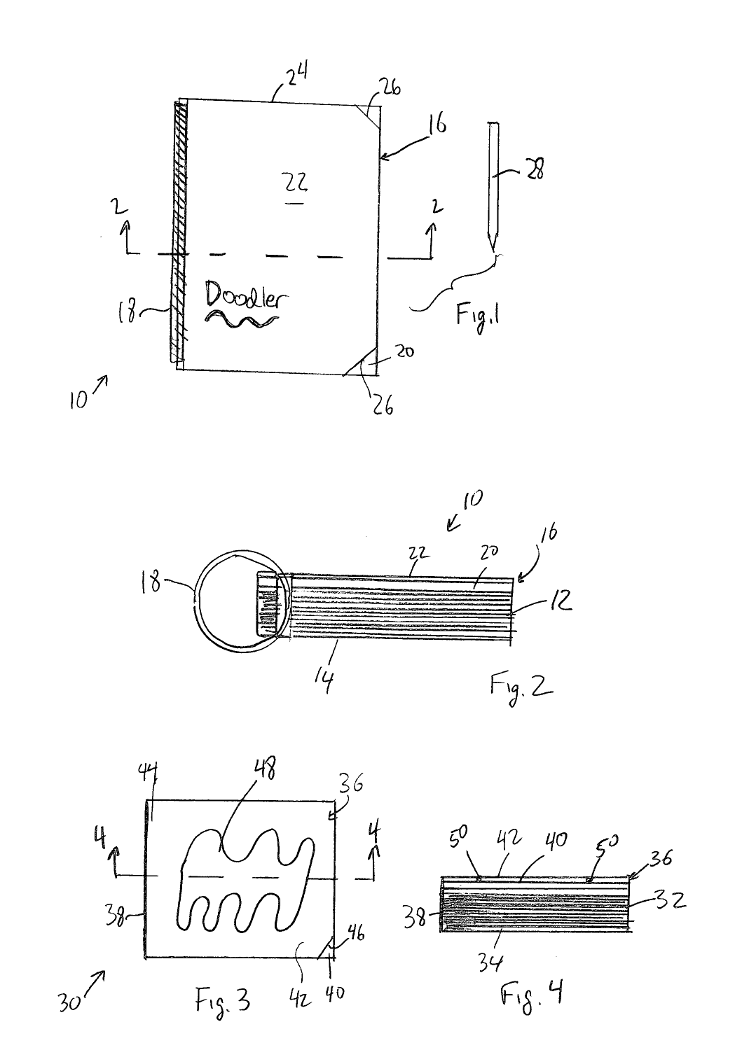

Referring now to FIGS. 3 and 4, a second embodiment of an article in accordance with the invention is shown and is a notepad 30 or journal (hereinafter referred to as a notepad). Notepad 30 has a plurality of sheets of paper 32, a back cover member 34 and a front cover member 36, all of which are attached to one another along an edge, e.g., adhesively attached to one another by at least an adhesive or glue 38 placed along an edge thereof as known in the art.

The front cover member 36 provides a surface to enable erasable writing thereon, similar to front cover member 16 described above. Thus, the front cover member 36 includes a substrate 40 and a transparent sheet 42 operatively coupled to one edge region 44 of the substrate 40, e.g., the left edge region as shown, and that overlies the substrate 40. In one embodiment, the transparent sheet 42 may be attached to a part of the front cover member 36 of the notepad 30 other than the substrate 40, but such that it overlies the substrate 40.

One or more corner regions 46 of the transparent sheet 42 may be removed to enable easy lifting up and separation of the transparent sheet 42 from the substrate 20 (see FIG. 3). The rigid substrate 40 may be the same member that bounds the sheets 32 on the top or a separate member, i.e., the substrate 40 is part of the front cover member 36 which is placed against another cover that hounds the sheets 32 on the top.

In use, when pressure is applied to the overlying transparent sheet 42 against the substrate 40, the pressure causes the transparent sheet 42 to appear to change its color, i.e., darken, and thereby adopt the form or shape of the areas in which the pressure is applied (see the shape 48 in FIG. 3 which results in darkened regions 50 of the front cover member in FIG. 4). Erasure of the formed writing or design is as described above for front cover member 16.

The materials for the substrate 40 and the transparent sheet 42 are known to those skilled in the art as explained above.

It is possible to include with the notepad 30, a stylus (not shown) that can be used to apply pressure to the transparent sheet 42. The stylus may be removably attached to the back cover member 34 or front cover member 36 using any conventional attachment structure known in the art.

The size and shape of the notepad 30 may vary as desired. A plurality of different size and shape notepads may be produced, each including a front over member 36 as described above. The front cover member 36 may occupy the maximum amount of area the front of the notepad 30 or only a portion thereof. In addition, multiple transparent sheets 42 may be provided, each overlying a discrete portion of the substrate 40 and each independently attached to substrate. In this case, different writing or designs may be produced, and each erased independent of the continued presence or erasure of the other writing or design.

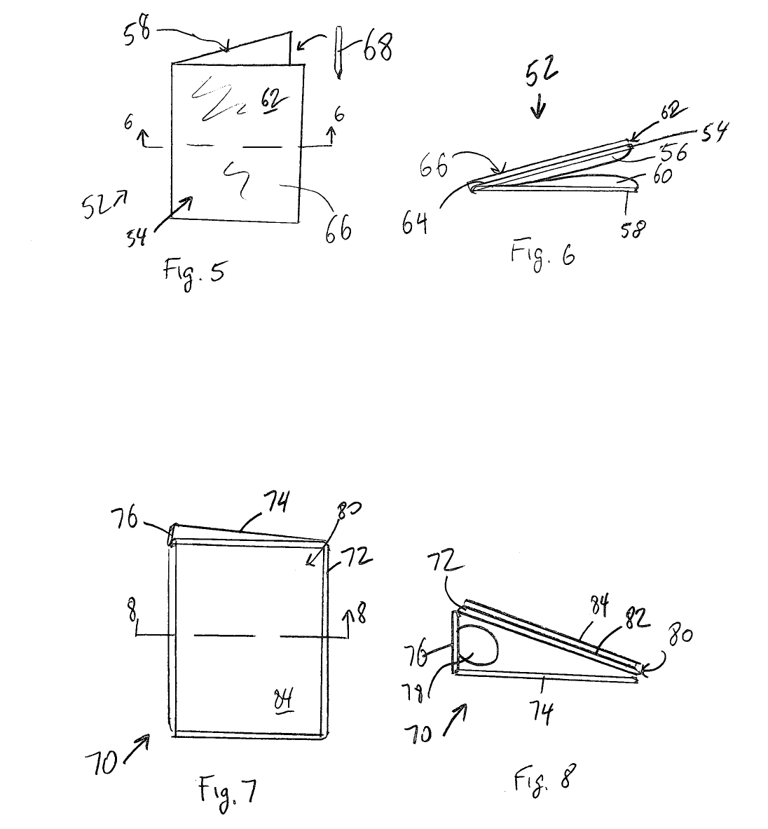

Referring now to FIGS. 5 and 6, a third embodiment of an article in accordance with the invention is a folder 52. Folder 52 has a front panel 54 defining a pocket 56, and a rear panel 58 defining a pocket 60 and that is pivotally connected to the front panel 54. The front panel 54 includes a front cover member 62. It is foreseen that a pocket need not be formed on both the front and rear panels, but only on one.

The front cover member 62 provides a surface to enable erasable writing thereon. Specifically, the front cover member includes a rigid substrate 64 and a transparent sheet 66 pivotally attached to one edge region of the substrate 64, e.g., the upper edge region, and that overlies the substrate 64. The rigid substrate 64 may be the same member that bounds the inside of the pocket 56 or a separate member, i.e., the substrate 64 is part of the front cover member 62 which is placed against another member that bounds the inside of the pocket 56.

Front cover member 62 is used in the same manner as front cover member 16 described above.

It is possible to include with the folder 52, a stylus 68 that can be used to apply pressure to the plastic sheet 66. The stylus may be sized to fin in the folder 52 for storage, or otherwise removably attached to the front panel 54, the rear panel 58 or the front cover member 62.

Referring now to FIGS. 7 and 8, a loose-leaf notebook 70 in accordance with the invention has a front panel 72, a rear panel 74, a side panel 76 that connects the front and rear panels 72, 74, and a binder structure 78 attached to the side and 76 and that removably receives sheets of paper (not shown).

The front panel 72 includes a cover member 80 that provides a surface to enable erasable writing thereon. Specifically, the cover member 16 includes a rigid substrate 82 and a transparent sheet 84 pivotally attached to one edge region 86 of the substrate 82, e.g., the upper edge region as shown, and that overlies the substrate 82. The rigid substrate 82 may be the same member that serves as the rigid top of the loose-leaf notebook 70 or a separate member, i.e., the substrate 82 is part of the cover member 80 which is placed against another panel that serves as the rigid top of the loose-leaf notebook 70. In one embodiment, the transparent sheet 84 may be attached to a part of the cover member 80 of the notebook 70 other than the substrate 82, but such that it overlies the substrate 82.

Cover member 80 is used in the same manner as cover member 16 described above.

The size and shape of the loose-leaf notebook 70 may vary as desired. A plurality of different size and shape loose-leaf notebooks may be produced, each including a cover member 80 as described above. The cover member 80 may occupy the entire front panel 72 of the loose-leaf notebook 70, or only a portion thereof. Multiple transparent sheets 84 may be provided, each overlying a discrete portion of the substrate 82 and each independently attached to substrate 82. As such, different writing or designs may be produced, and each erased independent of the continued presence or erasure of the other writing or design.

It is contemplated that a cover member defining the erasable writing surface as described above may be integrated into additional school supplies, office supplies and office storage solutions, in addition, to the spiral notebooks, journals, notepads and folders as described above and illustrated in FIGS. 1-8. The cover member does not have to serve as a front cover member on the front of the article, but may serve as a cover member on a different part of the article.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims. For example, the transparent sheet and/or substrate can be colored and/or provide a fluorescent appearance on the portions thereof which comprise the writing, design or image created by the user. It is also foreseen that the transparent sheet may instead be translucent.

1. An article for writing, comprising:
a front cover member;
a rear cover member operatively coupled to said front cover member,
said front cover member comprising a rigid substrate and a transparent sheet superposed relative to said substrate to overlie or be apart from said substrate,
whereby when pressure is applied to said transparent sheet against said substrate, the pressure causes said transparent sheet to darken and adopt the form or shape in which the pressure applied, when said transparent sheet is pivoted upward away from said substrate, the form or shape is erased, and when the said transparent sheet is then returned to a position overlying said substrate, said transparent sheet is ready to adopt a new form or shape.

2. The article of claim 1, further comprising a plurality of sheets of paper interposed between the front and rear cover members.

3. The article of claim 2, further comprising a spiral that attaches said sheets, said front cover member and said rear cover member together.

4. The article of claim 1, further comprising a spiral that operatively couples said front and rear cover members, wherein said spiral is arranged at an edge region of the article and said transparent sheet is attached to an upper edge region of said substrate.

5. The article of claim 4, further comprising a stylus removably arranged in connection with said spiral.

6. The article of claim 1, wherein said transparent sheet is formed with cut-out corner regions to enable lifting up of said transparent sheet from said substrate.

7. The article of claim 1, further comprising adhesive that operatively couples said front cover member and said rear cover member together.

8. The article of claim wherein said adhesive is arranged one of a left or right side of the article, said transparent sheet being arranged at an upper edge region of said substrate.

9. The article of claim 1, further comprising a stylus removably arranged in connection with the article.

10. The article of claim 1, wherein the transparent sheet comprises a flexible plastic material.

11. The article of claim 1, wherein the transparent sheet is pivotally operably coupled to the substrate.

12. A folder, comprising:
a front panel; and
a. rear panel, at least one of the front panel, and rear panel defining a pocket, the rear panel being operably coupled to said front panel,
said front panel including a front cover member comprising a rigid substrate and a transparent sheet superposed relative to said substrate to overlie or be apart from said substrate,
whereby when pressure is applied to said transparent sheet against said substrate, the pressure causes said transparent sheet to darken and adopt the form or shape in which the pressure is applied, when said transparent sheet is pivoted upward away from said substrate, the form or shape is erased, and when the said transparent sheet is then returned to a position overlying said substrate, said transparent sheet is ready to adopt a new form or shape.

13. The article of claim 12, further comprising a stylus removably arranged in connection with said front panel or said rear panel.

14. The article of claim 11 wherein the transparent sheet comprises a flexible plastic material.

15. The article of claim 11 wherein the transparent sheet is pivotably operably coupled to the substrate.

16. A loose-leaf notebook, comprising:
a front panel;
a rear panel;
a side panel that operatively couples said front and rear panels, and
a binder structure coupled to said side panel and that removably receives sheets of paper,
said front panel including a cover member comprising a rigid substrate and a transparent sheet superposed relative to said substrate to overlie or be apart from said substrate,
whereby when pressure is applied to said transparent sheet against said substrate, the pressure causes said transparent sheet to darken and adopt the form or shape in which the pressure is applied, when said transparent sheet is moved upward away from said substrate, the form or shape is erased, and when the said transparent sheet is then returned to a position overlying said substrate, said transparent sheet is ready to adopt a new form or shape.

17. The notebook of claim 14, wherein said transparent sheet is pivotally attached to said substrate.

18. The notebook of claim 14, wherein the transparent sheet comprises a flexible plastic material.

19. The notebook of claim 14, wherein the transparent sheet is pivotably operably coupled to the front panel.
